(19) United States
(12) Patent Application Publication
(10) Pub. No.: US 2003/0229516 A1
(43) Pub. Date: Dec. 11, 2003

(54) System and method for rapid claims submission and adjudication

(76) Inventor: Christian Nickerson, West Winder, NJ (US)

Correspondence Address: Gibson, Dunn & Crutcher LLP, Suite 4100, 1801 California Street, Denver, CO, 80202, US

(21) Appl. No.: 10/360,527

(22) Filed: Feb. 7, 2003

Related U.S. Application Data
(60) Provisional application No. 60/355,225, filed on Feb. 7, 2002.

(51) Int. Cl. G06F 17/60

(52) U.S. Cl. 705/2

(57) ABSTRACT

A system and method for rapid claim submissions by healthcare providers is disclosed. The system and method utilizes middleware applications to obtain point of service adjudications of healthcare claims. A polling procedure that tests middleware and claim engine availability ensures that transactions are carried out in a seamless manner and real-time updates are provided to the healthcare provider.

System and method for rapid claim submissions by a healthcare provider. This application claims priority from U.S. provisional application serial No. 60/355,225.

### BACKGROUND OF THE INVENTION

1. Field of the Invention

The invention is related to the medical insurance industry and specifically to the process of adjudicating claim submissions via the Internet.

2. Description of the Related Art

Currently, it is not uncommon for healthcare providers (hereinafter “Providers”) to submit batches of medical insurance claims to Payers (hereinafter “Payers”) via the Internet. The problems associated with these Internet insurance transactions include: (a) the claims contain too little or erroneous information and are, consequently rejected by the Payers claim engine; (b) may have whole batches of claims rejected because of an error in an individual claim; (c) batch claims are difficult to manage and a Provider may be unsure as to the status of individual claims within a batch; and (d) Payer claim engines are very often attached to the Payer's legacy system, which may not be able to handle Internet transactions or do so at a high transaction cost.

### BRIEF SUMMARY OF THE INVENTION

The following invention addresses the above-mentioned needs in the art by providing a method for rapid claim submission and adjudication. The described system and method for rapid claims submission and adjudication is a unique application that enables point of service adjudication of claims over the Internet in real-time. Point of service adjudication is the process of submitting claims online to the claim Engine and receiving immediate feedback as to the status of the submitted claim. The point of service adjudication is possible because the invention incorporates a method for formatting the Payer's legacy system information in such a way that it can be used directly by an XML based middleware layer with little transactional overhead and, therefore, a claim engine connected to a legacy system can seamlessly process the Provider's claim submissions.

The claimed invention also addresses the other problems associated with claim submissions and adjudications. First, the system and method includes an editing process whereby each claim submission is edited so that errors are identified prior to the submission of a claim to the claim Engine. Furthermore, claimed invention breaks batch claims down into individual claim submissions and tracks these individual claims providing a status update to the Provider as the claims are submitted to the claim engine.

### BRIEF DESCRIPTION OF THE FIGURES

FIG. 1 is a block diagram illustrating a preferred embodiment of the present invention.

FIG. 2 is a flow diagram illustrating the polling process.

### DETAILED DESCRIPTION OF THE INVENTION

Reference will now be made in detail to the construction and operation of preferred implementations of the present invention illustrated in the accompanying drawings. In those drawings like elements and operations are designated with the same reference numbers when possible.

The following description of the preferred implementations of the present invention is only exemplary of the invention. The present invention is not limited to these implementations, but may be realized by other implementations.

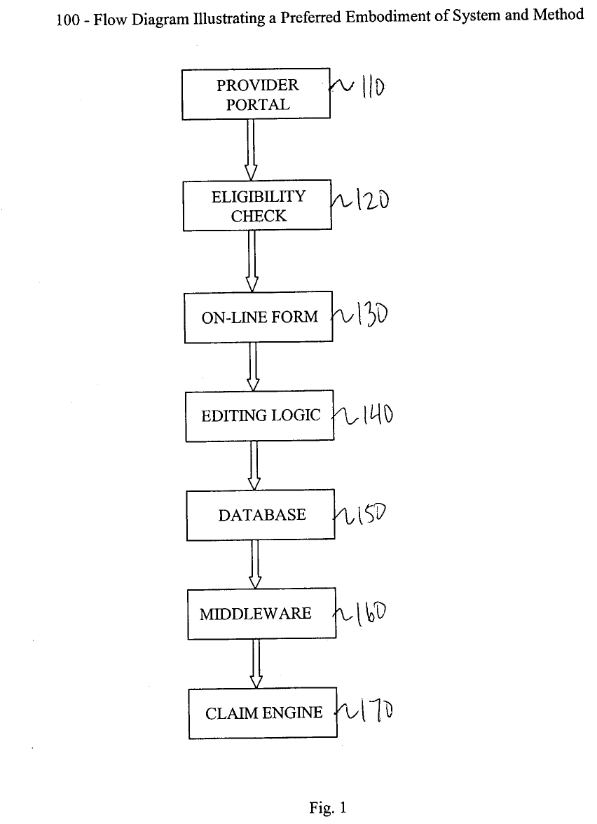

FIG. 1 is a functional block diagram showing a system 100 for rapid claim submission and adjudication.

A Provider begins the rapid claims submission process by accessing the Internet. This is typically done through the Provider Portal 110. Initially, a check is performed to ensure that the person submitting the claims is authorized to perform transactions on behalf of the Provider. In a preferred embodiment of the invention, the Provider Portal 110 interfaces with the providers in house Physician Office Management and Information System (“POMIS”) by identifying the location of the claim file and initiates a file transfer using a secure Internet protocol to deliver batch claim submissions in the National Standard Format or ANSI X12 837 formats.

After accessing the Internet the Provider performs an Eligibility Check 120 to ensure that any claims to be submitted relate to parties covered by the Payer (hereinafter referred to as the “Member” or “Members”). To effectuate the Eligibility Check, the Payer provides access to Member records online. By simply entering a Member ID number or swiping the Insurance ID card, the user is presented with Member and dependent plan information, history, plan-specific benefit details and limits. Family and individual deductibles utilized/remaining are calculated as well. By verifying eligibility initially, the integrity of the claims being entered through the portal is maintained. The information accessed here will persist throughout the session on the portal and be reused where appropriate to eliminate the keying of demographic data.

Claim submission via the Internet mirrors the existing process for submission of medical claims to Payers in that the Provider accesses through the Provider Portal 110 a web version of a Health Care Financing Administration (hereinafter “HCFA”) 1500 form. The system and method may be updated to mirror on-line any new paper or electronic form required for claim submissions. The On-Line Form 120 is completed by the Provider. In a preferred embodiment of the invention, completion of the On-Line Form 130, or any other type of submission form, is expedited by the use of pre-filled patient and provider information and pre-configured drop down boxes for such fields as Place of Service, & Type of Service. Also integrated on the On-Line Form 130 is a search process for ICD9 diagnosis codes and CPT4 procedure codes. All fields on the online Form 130 can be tabbed between for rapid data entry.

Though many portions of the On-Line Form 130 have been pre-filled or pre-defined, there are still certain elements that must be entered by the user. Using payer claim Engine analysis, valid formats and field sizes for all data elements can be determined for the On-Line Form 130. In a preferred embodiment of the invention, this logic (hereinafter referred to as “Editing Logic”) is then built into the Provider Portal 110. The Editing Logic 140 draws the Provider's attention to any incompatible data and halts the submission process. Once the OnLine Form 130 has been corrected, it is ready for submission. The Editing Logic 140 virtually eliminates the likelihood of a claim being sent to the Payer that is either incomplete or contains mis-keyed or erroneous information.

After the On-Line Form 120 has been completed and successfully passed through the Editing Logic 140, it is submitted to the payer's claim Engine 170. The On-Line Form is submitted to the claim Engine 170 via Middleware 160. The claim Engine 170 has been modified to have a real-time single claim interface exposed to a mid-tier application layer via Middleware 160. This single claim interface contains industry standard claim line level bundling & unbundling processes.

The submission process starts when a claim is ready for submission after successfully passing through the Editing Logic 140. The claim is then stored in an appropriate storage means. In a preferred embodiment of the invention, the claim is stored in a dedicated table in the Database 150. Each claim in the system is given a claim identification. In a preferred embodiment of the invention, the claim identification is generated on the middle tier through a database storage procedure. Each claim identification is unique. In a preferred embodiment of the invention, the fact that the claims occupy shared instances of the database guarantees this uniqueness.

Once the claims have been appropriately stored, the claim is modified and then sent to the claim Engine 170 via the middleware. The claim is modified so that it can be processed by the claim Engine 170. In a preferred embodiment of the invention the modified claim is a string version of the On-Line Form 130 that is produced by the Provider Portal and then converted through a real-time transaction into the payer-appropriate entry format.

A modem claim Engine 170 can interact with the Middleware 160 so that claims submitted via the Internet may be processed. However, claim Engines connected to Legacy Systems cannot effectively process Internet claims. As such, this invention incorporates by reference the patent application attached as Legacy Data Conversion method as described in Appendix 1. This attached patent application describes an invention that allows a claim engine attached to a Legacy System to communicate and interact with middleware. Utilizing the invention described in Appendix 1, the claim Engine 170, even if connected to a Legacy System, is able to interact with the Middleware 160 and process the modified Internet claim.

Finally, once the claim Engine has processed the Provider's claim, the Provider is notified as to the result of the claim. In the preferred embodiment of the invention, the Provider receives via the Provider Portal payment or rejection details of the claim.

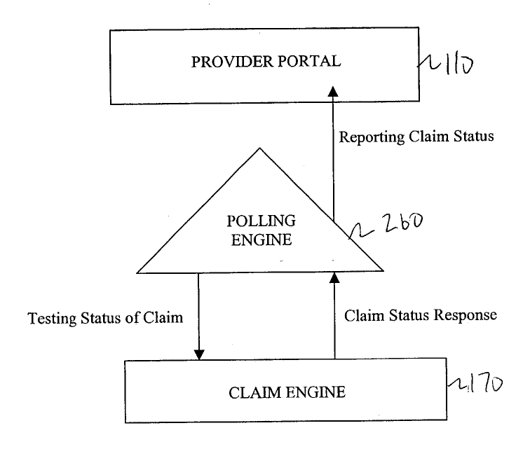

FIG. 2 illustrates the polling process. Although the described invention is designed to work in real-time, the processing of a claim or claims may not be instantaneous. Consequently, the described invention includes a process to keep the Provider informed as to the status of his or her claims. This method avoids duplication of claims by the Provider when he or she is unsure if the claim was sent correctly to the claim Engine and provides for effective claim management.

The polling process is the process of submitting a business request from the Provider Portal 110 through a middleware bridge to the claim Engine 170 and monitoring the status of the submitted request. This has been termed polling to describe the action of inquiring as to the status of the submitted request. The polling process described in the invention may be configurable and scalable across different machines in a network as well as multiple instances of an application server. A fail-over mechanism may also be utilized in the described invention to guarantee that no claim is lost during transitions.

Every claim submitted to the Payer claim Engine 170 is then tracked by the mid-tier Polling Engine 260 application. On predefined and configurable intervals the Polling Engine 260 will seek and monitor the status of submitted claims until they reach a predefined final status. Upon reaching the finalized state the user is sent a notice. The polling then subsides for finalized claims.

As discussed previously, in a preferred embodiment of the invention, a fail-over mechanism may be employed whereby the string image of every claim is stored in a database table. The polling process then begins and the Polling Engine 260 periodically checks the state of all unfinalized claims. Every change in a claim's state is logged. In a preferred embodiment of the invention, the status of a claim is logged in a database table.

Every claim goes through a number of states before being considered “finalized”. When the Polling Engine 260 receives a finalized state for a claim from the claim Engine 170, it stops polling completely. If the Polling Engine 260 receives a status that indicates failure of the claim to pass the claim Engine 170, it is considered a recoverable error if the mainframe was down and when a message is received that the claim Engine 170 is back online, the claim is reissued. If the claim is determined to produce a non-recoverable error, the claim requires manual intervention and an Error Report 280 is produced to prompt manual intervention.

The Polling Engine sends information regarding the status of a claim, in real-time to the Provider. The information can be sent in many different forms, including a notice to the Provider Portal, an instant message or a wireless communication. The Polling Engine can be set to send continuous updates or to give discrete updates as the status of a claim changes.

The following illustrate the polling process and claim status according to the availability of the Middleware 160 and the claim Engine 170.

All Systems are Functioning. In this event, the claim is immediately adjudicated. Initially, the claim is formed in a middle tier and stored in a local Database 150, but not yet presented to Middleware 160. The claim is successfully forwarded to the claim Engine 170 and tracked by the Middleware 160. Middleware 160 confirms acceptance of the request by the claim Engine 170 and polling begins. Once polling of the claim Engine 170 returns a state of ‘finalized’, polling subsides at this point for this claim.

Claim Engine 170 is unable to locate the submitted claim. The claim is formed in middle tier and stored in a local Database 150, but not yet presented to the Middleware 160. The claim is successfully forwarded to the claim Engine 170 and tracked by the Middleware 160. Middleware confirms acceptance of the request by the claim Engine 170 and Polling begins. The polling process unsuccessfully attempts to check the status of the claim because the claim has not been found by the claim Engine in the claim engine database. Polling continues. Request was submitted considerably long ago, time variations can be set by the Provider or Payer. If claim is still not found after set period of time the polling aborts and manual intervention is requested. Once manual intervention occurs the stored state of the claim is changed to ‘Reissue.’

Middleware Unavailable. Claim is formed in middle tier and stored in a local Database 150, but not yet presented to Middleware 160. Application checks Middleware 160 availability and determines that Middleware 160 is down. Claim will be submitted again because precondition of Middleware 160 and claims Engine 170 being operational was not fulfilled. Claim is reissued for submission and goes back to ‘initial’ state. Claim is formed in middle tier and stored in a local Database 150, but not yet presented to Middleware 160. Main submission flow resumes

Claim Engine Unavailable. Claim is formed in middle tier and stored in a local Database 150, but not yet presented to middleware. Application checks claim Engine 170 availability and determines that claim Engine 170 is down. Claim is submitted again because precondition of Middleware 160 and claim Engine 170 being operational was not fulfilled. Claim is reissued for submission and goes back to ‘initial’ state. Claim is formed in middle tier and stored in a local Database 150, but not yet presented to middleware. Normal claim submission flow resumes.

Claim Engine operating in inquiry-only mode. Claim is formed in middle tier and stored in a local Database 150, but not yet presented to Middleware 160. The claim successfully reaches Middleware 160, but since the claim Engine 170 is operating in inquiryonly mode, the claim will sit in the Middleware 160 queue until the claims Engine 170 is fully operational. Queued claim has been successfully put into the Middleware 160 queue to wait for the claim Engine 170 to become fully operational. Middleware 160 is notified that the request has been processed by the claim Engine 170. Middleware 160 has confirmed acceptance of the request by the claim Engine 170. Polling begins and claim submission flow resumes.

What is claimed is:

1. A system and method for rapid submission and adjudication of healthcare claims comprising the steps of:
a. formatting a healthcare claim form into payer approved format;
b. creating a transaction record by storing an attribute relating to said healthcare claim;
c. submitting the healthcare claim to a claim adjudication engine via the Internet;
d. updating the transaction record as to the status of the healthcare claim; and
e. sending a healthcare-claim status update to the submitter of the healthcare claim.

2. A system and method for rapid submission and adjudication of healthcare claims comprising the steps of:
a. entering a healthcare claim into a web portal;
b. interfacing the web portal with a claim adjudication engine using a middleware application;
c. sending the healthcare claim to the claim adjudication engine via the middleware; and
d. updating in real-time the result of the claim adjudication on the web portal.
